(19) United States
(12) Patent Application Publication
(10) Pub. No.: US 2025/0245965 A1
(43) Pub. Date: Jul. 31, 2025

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventor: Yoshikazu WATANABE, Tokyo (JP)

(73) Assignee: NEC Corporation, Minato-ku, Tokyo (JP)

(21) Appl. No.: 18/703,578

(22) PCT Filed: Nov. 18, 2021
(86) PCT No.: PCT/JP2021/042390

§ 371 Date: Apr. 22, 2024

(51) Int. Cl. G06V 10/764; G06V 10/10; G06V 10/774; G06V 10/82; G06V 20/62

(52) U.S. Cl. CPC G06V 10/764; G06V 10/16; G06V 10/774; G06V 10/82; G06V 20/625; G06V 2201/07

(57) ABSTRACT

An information processing device according to the present invention includes: a memory configured to store instructions; and one or more processors configured to execute the instructions to: generate configuration data comprising a plurality of sets of data including an inference target; infer a target included in the configuration data; infer a target; and determine, for each set of data constituting the configuration data, whether the inference on the target included in the configuration data is successful or unsuccessful, infer a target included in a set of data for which the inference on the target included in the configuration data is successful and the result of the inference on the target, and infer a target included in a set of data for which the inference on the target is unsuccessful, based on the result of performing inference on a target included in data.

### TECHNICAL FIELD

The present invention relates to inference processing using machine learning.

### BACKGROUND ART

NPLs 1 to 4 disclose technologies related to inference processing of an image using deep learning.

### CITATION LIST

### Non Patent Literature

NPL 1: Kaiming He, Xiangyu Zhang, Shaoqing Ren, Jian Sun, “Deep Residual Learning for Image Recognition”, [online], 10 Dec. 2-15, Cornel University, [Searched on Oct. 13, 2021], Internet <URL: https://arxiv.org/abs/1512.03385>

NPL 2: Shaoqing Ren, Kaiming He, Ross Girshick, Jian Sun, “Faster R-CNN: Towards Real-Time Object Detection with Region Proposal Networks”, [online], 6 Jan. 2016, Cornel University, [Searched on Oct. 13, 2021], Internet <URL: https://arxiv.org/abs/1506.01497>

NPL 3: Wei Liu, Dragomir Anguelov, Dumitru Erhan, Christian Szegedy, Scott Reed, Cheng-Yang Fu, Alexander C. Berg, “SSD: Single Shot MultiBox Detector”, [online], 29 Dec. 2016, Cornel University, [Searched on Oct. 13, 2021, Internet, <URL: https://arxiv.org/abs/1512.02325>

NPL 4: Tsung-Yi Lin, Priya Goyal, Ross Girshick, Kaiming He, Piotr Dollar, “Focal Loss for Dense Object Detection”, [online], 7 Feb. 2018, Cornel University, [Searched on Oct. 13, 2021], Internet, <URL: https://arxiv.org/abs/1708.02002>

### SUMMARY OF INVENTION

### Technical Problem

NPLs 1 to 4 do not disclose a technique related to improvement in throughput of inference processing. An object of the present invention is to provide an information processing device and the like that improve throughput of inference processing.

### Solution to Problem

A device according to an aspect of the present invention includes:
a data configuration means that generates configuration data configured using a plurality of pieces of data, at least a portion of which including an inference target;
a configuration data inference means that performs inference on the target included in the configuration data;
a data inference means that performs inference on the target included in the data in at least a portion of the data; and
a target inference means that is configured to:
   determine whether inference on the target included in the configuration data has succeeded or failed for each piece of the data constituting the configuration data;
   perform inference on the target based on the configuration data and a result of performing inference on the target included in the configuration data as inference on the target included in the data for which inference on the target included in the configuration data has succeeded; and
   perform inference on the target based on a result of performing inference on the target included in the data as inference on the target included in the data for which inference on the target included in the configuration data has failed.

A system according to an aspect of the present invention includes:
the above information processing device;
a data acquisition device that outputs a plurality of pieces of the data at least partially including the target to the information processing device; and
a recognition device that acquires a result of performing inference on the target from the information processing device and executes recognition related to the target based on the acquired inference result.

An information processing method according to an aspect of the present invention includes:
generating configuration data configured using a plurality of pieces of data, at least a portion of which including an inference target;
performing inference on the target included in the configuration data;
performing inference on the target included in the data in at least a portion of the data;
determining whether inference on the target included in the configuration data has succeeded or failed for each piece of the data constituting the configuration data;
performing inference on the target based on the configuration data and a result of performing inference on the target included in the configuration data as inference on the target included in the data for which inference on the target included in the configuration data has succeeded; and
performing inference on the target based on a result of performing inference on the target included in the data as inference on the target included in the data for which inference on the target included in the configuration data has failed.

An information processing method according to an aspect of the present invention includes:
executing, by an information processing device, the above method;
outputting, by a data acquisition device, a plurality of pieces of the data at least partially including the target to the information processing device; and
acquiring, by a recognition device, a result of performing inference on the target from the information processing device and executing recognition related to the target based on the acquired inference result.

A recording medium according to an aspect of the present invention has stored therein a program causing a computer to execute:
generating configuration data configured using a plurality of pieces of data, at least a portion of which including an inference target;
performing inference on the target included in the configuration data;
performing inference on the target included in the data in at least a portion of the data;
determining whether inference on the target included in the configuration data has succeeded or failed for each piece of the data constituting the configuration data;
performing inference on the target based on the configuration data and a result of performing inference on the target included in the configuration data as inference on the target included in the data for which inference on the target included in the configuration data has succeeded; and
performing inference on the target based on a result of performing inference on the target included in the data as inference on the target included in the data for which inference on the target included in the configuration data has failed.

### Advantageous Effects of Invention

According to the present invention, the throughput of inference processing can be improved.

### BRIEF DESCRIPTION OF DRAWINGS

FIG. 1 is a diagram illustrating an example of a configuration of an information processing device according to a first example embodiment of the present invention.

FIG. 2 is a diagram illustrating an example of a relationship between a CNN size and utilization efficiency of operation resources.

FIG. 3 is a schematic diagram illustrating an example of an NN used in an image classification task.

FIG. 4 is a schematic diagram illustrating an example of an NN used in an object detection task.

FIG. 5 is a block diagram illustrating an example of a configuration of an information processing device according to a second example embodiment.

FIG. 6 is a diagram illustrating an example of a configuration image.

FIG. 7 is a flowchart illustrating an example of an operation of generating a trained model in the information processing device according to the second example embodiment.

FIG. 8 is a flowchart illustrating an example of an operation of executing inference on a target in the information processing device according to the second example embodiment.

FIG. 9 is a block diagram illustrating a configuration of an example of a variation of the information processing device according to the second example embodiment.

FIG. 10 is a block diagram illustrating an example of a configuration of an information processing device according to a third example embodiment.

FIG. 11 is a block diagram illustrating an example of a hardware configuration of the information processing device.

FIG. 12 is a block diagram illustrating an example of a configuration of an information processing system including an information processing device.

### EXAMPLE EMBODIMENT

Hereinafter, each example embodiment of the present invention will be described with reference to the drawings. Each drawing is for describing each example embodiment. However, each example embodiment is not limited to the description of each drawing. Each example embodiment can be appropriately combined.

### First Example Embodiment

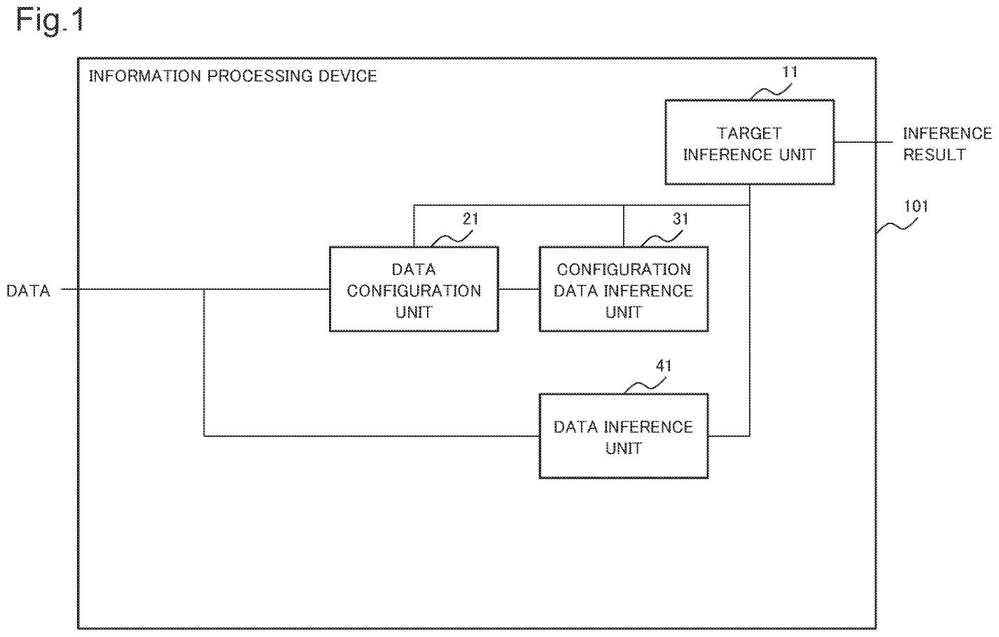

FIG. 1 is a block diagram illustrating an example of a configuration of an information processing device 101 according to a first example embodiment of the present invention. The information processing device 101 includes a target inference unit 11, a data configuration unit 21, a configuration data inference unit 31, and a data inference unit 41. The data configuration unit 21 generates configuration data configured using a plurality of pieces of data, at least a portion of which includes an inference target. The configuration data inference unit 31 performs inference on a target included in the configuration data. The data inference unit 41 performs inference on a target included in at least a portion of data. The target inference unit 11 determines whether inference on a target included in the configuration data has succeeded or failed for each piece of data constituting the configuration data. Then, the target inference unit 11 performs inference on the target based on the result of performing the inference on the configuration data and the configuration data as inference on the target included in the data for which inference on the target included in the configuration data has succeeded. Then, the target inference unit 11 performs inference on the target based on the result of performing the inference on the data as inference on the target included in the data for which inference on the target included in the configuration data has failed.

The data configuration unit 21 generates configuration data that is data larger in scale than the data using a plurality of pieces of data including an inference target. The configuration data inference unit 31 performs inference on a target included in the configuration data. For the data for which inference on the target has succeeded in the configuration data inference unit 31, the target inference unit 11 performs inference on the target based on the configuration data and the result of performing the inference on the target included in the configuration data that is data larger in scale than the data. That is, the information processing device 101 performs inference on the target based on a result of inference using configuration data that is data larger in scale than data including the target. Next, a relationship between the size of data and improvement in throughput of inference processing will be described.

Image inference processing using machine learning represented by an image classification task, an object detection task, and the like is processing with a high load. Therefore, various types of hardware have been developed as hardware (HW) for executing such inference processing at high speed. Examples of such HW include a graphics processing unit (GPU) and a field programmable gate array (FPGA). Alternatively, such HW is, for example, an application specific integrated circuit (ASIC) or an artificial intelligence (AI) chip. In the following description, the HW for performing these inference processing is collectively referred to as “AI devices”.

In order to achieve high-speed and high-throughput inference processing, these AI devices include a large number of arithmetic units, divide an input image, and process the divided images in parallel in mutually different arithmetic units. Alternatively, the AI device performs inference processing by pipelined combination of a plurality of arithmetic units having different functions. Even in a chip called a central processing unit (CPU), there is a chip including a large number of arithmetic units or an arithmetic unit for a specific application such as a matrix operation frequently used in machine learning as an arithmetic unit inside. That is, the CPU includes a CPU including an arithmetic unit relevant to an AI device. Therefore, in the following description, the AI device includes a CPU including an arithmetic unit relevant to the above-described AI device unless a particularly distinguished description is required.

The AI device can execute inference processing with high throughput. However, since the AI device implements a high throughput by operating a large number of arithmetic units in parallel, it is necessary to operate a large number of arithmetic units at a high operation rate. For example, in a case where the size of the image is small, the AI device cannot sufficiently utilize parallelism in a large number of arithmetic units, and thus, cannot achieve a high throughput. The target data of the AI device is not limited to two-dimensional data such as an image. For example, the AI device may operate on three-dimensional data such as data acquired using a radar (Radio Detecting and Ranging (RADAR)) or a light detection and ranging (LiDAR).

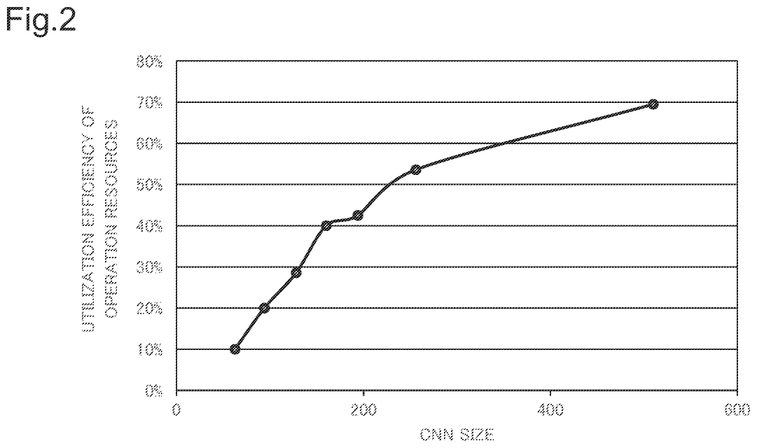

FIG. 2 is a diagram illustrating an example of a relationship between the size of a convolutional neural network (CNN) used in parallel and the utilization efficiency of operation resources measured using a certain AI device. The utilization efficiency in FIG. 2 is a value obtained by dividing the arithmetic performance obtained at the time of the actual inference processing by the maximum arithmetic performance obtained from the operation resources included in the AI device. The unit of the arithmetic performance is, for example, a giga floating-point operations per second (GFLOPS), but is not limited thereto. As illustrated in FIG. 2, in a case where the CNN size to be used is about 500, the utilization efficiency is about 70% of the maximum arithmetic performance of the AI device. However, in a case where the CNN size to be used is equal to or less than 100, the utilization efficiency is equal to or less than 20% of the maximum arithmetic performance of the AI device.

As described above, the higher the parallelism, the higher the utilization efficiency of the AI device, and the higher the throughput of the inference processing. Inference using data including a plurality of targets and increasing the size of data of the inference target are effective methods for increasing parallelism. Therefore, the information processing device 101 according to the first example embodiment generates configuration data configured using a plurality of pieces of data as data having a large size. Then, the information processing device 101 performs inference by using the configuration data, thereby improving parallelism in the AI device, and as a result, improving throughput of inference processing.

However, there is a case where inference on a target included in configuration data configured using a plurality of pieces of data including the target is more likely to fail inference on a part of the targets than inference on a target included in individual data. Therefore, the information processing device 101 includes a data inference unit 41. The data inference unit 41 performs inference on a target included in the data. Then, the target inference unit 11 performs inference on the target using the inference result of the data inference unit 41 for the data for which inference on the target has failed in the configuration data inference unit 31. Therefore, the information processing device 101 can also perform inference on a target for data for which inference on the target included in the configuration data has failed.

### Second Example Embodiment

### Description of Related Inference Task

An inference task related to the description of the second example embodiment will be described. An image classification task is one of important tasks in image analysis using machine learning. The image classification task is a task of determining or classifying a class of an object shown in an image from classes given in advance. In recent years, among machine learning, an image classification task using deep learning has been widely used. In the machine learning of the image classification task, images for learning and class information of a target shown in each image are given as correct answer data. Then, the image classification task acquires a trained model by machine learning using the images for learning and the class information. Then, the image classification task applies the trained model to the image including the target, infers a class of the target in the image, and outputs the inferred class.

An inference task such as an image classification task may output information related to inference such as confidence of inference in addition to an inference result. For example, the image classification task may output the confidence of the inference in addition to the class. In the following description, as an example, the inference task used for the description outputs a set of an inference result and confidence. However, this does not limit the task used in the present example embodiment. Each task may not output the confidence, or may output a value different from the confidence. Therefore, in the following description, description of information related to inference such as confidence may be omitted unless particularly necessary. The image classification task may output a plurality of sets of classes and confidence for one image.

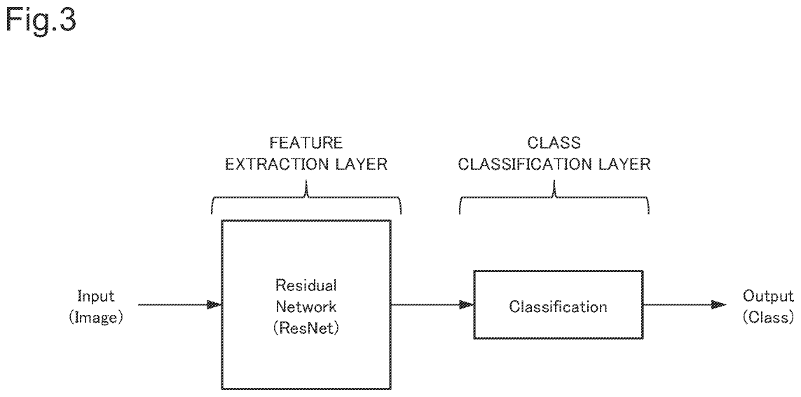

An example of a configuration of an image classification task will be described with reference to the drawings. FIG. 3 is a diagram illustrating an example of a neural network (NN) used in the image classification task. The NN in FIG. 3 includes a feature extraction layer and a class classification layer. FIG. 3 includes “Residual Network (ResNet)” as an example of the feature extraction layer. The ResNet is one of NN models, and is a model that does not learn “optimal output obtained in a certain layer” but learns “residual function with reference to input of a layer”. In FIG. 3, the image is first input to the feature extraction layer. The feature extraction layer calculates a feature related to the image and outputs the feature to the class classification layer. The class classification layer outputs a set of the class and the confidence of the object shown in the image based on the feature.

As one of other main tasks in image analysis using machine learning, there is an object detection task in an image. The object detection task is a task of generating a list of sets of a position, a class, and confidence of a detection target present in an image. Deep learning is also widely used for an object detection task. In the machine learning of the object detection task, images for learning, a position of a detection target in each image, and a class of the detection target are given as correct answer data. The position of the object is not limited to the following, but coordinates (bounding box (BB)) of four vertices of a rectangular region in which the object appears are often used. In the following description, BB is used as an example of the position of the detection target.

Then, the object detection task acquires a trained model by machine learning using the images for learning, the position of the detection target in the image, and the class of the detection target. Then, the object detection task applies the trained model to the image including the detection target, infers the BB and the class of the detection target in the image, and outputs a set of the inferred BB, the class, and the confidence of the detection target. When a plurality of targets are included in the image, the object detection task outputs a set of the BB, the class, and the confidence of each of the plurality of detection targets included in the image.

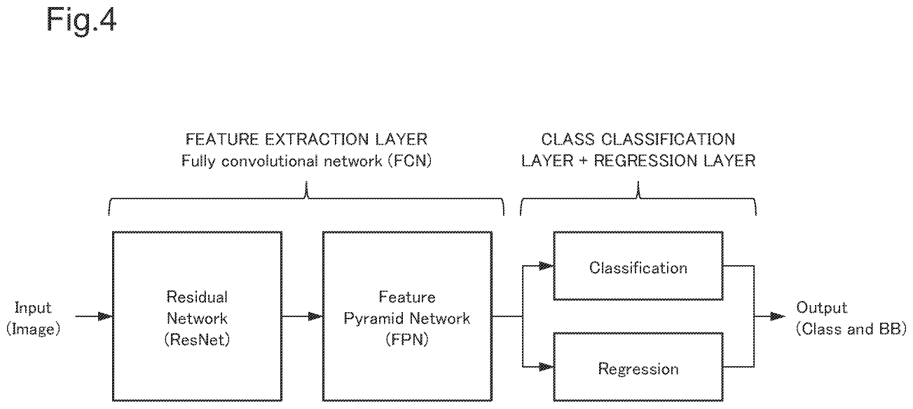

An example of an object detection task will be described with reference to the drawings. FIG. 4 is a diagram illustrating an example of an NN used in the object detection task. The NN illustrated in FIG. 4 includes a feature pyramidal network (FPN) in the feature extraction layer and a regression layer in addition to the configuration of the NN in FIG. 3. In FIG. 4, the ResNet and the FPN in the feature extraction layer calculate a feature regarding an input image using a method called “fully convolutional network (FCN)”. The class classification layer outputs the class of the object shown in the image based on the feature. The regression layer outputs the position of the object shown in the image based on the feature. For example, the regression layer outputs a BB as a position.

For example, a vehicle monitoring system can be constructed using an object detection task. More specifically, for example, the monitoring system acquires an image from a monitoring camera, inputs the acquired image to the object detection task, and acquires the class and position of the vehicle shown in the image from the object detection task. Then, the monitoring system displays the class and position of the vehicle by superimposing the class and position on the image from the monitoring camera. The user of the monitoring system may determine the vehicle shown in the image of the monitoring camera by using the displayed class and position of the vehicle. The object detection task may be used in combination with other recognition processing. For example, a license plate recognition system can be constructed by combining the following tasks.
An object detection task that detects a position and a class of a license plate of a vehicle included in an image.
A region determination task of determining a candidate region of each character of the detected license plate.
An image classification task of classifying characters appearing in an image with an image of the determined candidate region as an input.

The object detection task may detect the position and class of each character of the license plate included in the image.

The inference processing of the image classification task and the object detection task is required to have a high throughput. For example, the image classification task and the object detection task using the video from the monitoring camera need to operate at a high frame rate to some extent in order to prevent overlooking. In particular, when an object moving at a high speed such as a vehicle is targeted, the image classification task and the object detection task need to operate at a high frame rate. For example, it is desirable that the object detection task of detecting a vehicle in a video from the monitoring camera operates on a video at a frame rate equal to or more than 100 frames per second (fps). Alternatively, a monitoring camera or a device around the monitoring camera, i.e., an edge, may perform the image classification task or the object detection task. In such edge environments, limited computational resources may be available due to constraints such as installation location, cooling, and power. The image classification task and the object detection task are required to operate at a high throughput even in such an edge environment.

The AI device can execute inference processing with high throughput. However, since the AI device implements a high throughput by operating a large number of arithmetic units in parallel, it is necessary to operate a large number of arithmetic units at a high operation rate. Then, as described above, increasing the size of data of an inference target is an effective method for increasing parallelism. Therefore, similarly to the first example embodiment, an information processing device 100 of the second example embodiment improves the throughput of the inference processing by using the configuration data which is data having a larger size than the data for the inference on the target included in the data, as described below.

### Outline of Second Example Embodiment

In the following description, the information processing device 100 according to the second example embodiment uses an image that is two-dimensional data as an example of data. Then, the information processing device 100 executes an image classification task for classifying images as an example of the inference task. More specifically, the information processing device 100 executes an image classification task for an image in which characters are captured, that is, a character image, as a classification target. For example, the information processing device 100 acquires an image of each character in a license plate (LP) of a vehicle, and infers a class of characters included in the image. That is, the character included in the image is the inference target. Inference of the class of characters is inference on a target.

However, the information processing device 100 does not directly infer the class of characters in the acquired image, but infers the class of characters using the configuration image including the acquired image. Specifically, the information processing device 100 generates a configuration image in which a plurality of images are arranged on a plane, and infers the class of characters in the generated configuration image. In other words, the information processing device 100 generates a configuration image that is an image having a larger size than the original image by collecting a plurality of images in which at least a portion of the image include characters to be inferred. Then, the information processing device 100 performs inference on the generated configuration image and infers the class of characters included in the configuration image. Specifically, the information processing device 100 infers the position and class of each character in a configuration image including a plurality of images including characters.

The image classification task is a task of inferring the class of a target included in an image. However, the image classification task basically infers the class of an object in an image including one object to be classified. Therefore, in the image classification task, parallelism of the inference processing is not necessarily high. On the other hand, since the object detection task infers the position and class of each target in the inference using the image including the plurality of targets, there is a high possibility that parallelism becomes higher than that of the image classification task. Therefore, in the following description, the information processing device 100 uses an object detection task in inference of a configuration image. By using such a configuration, the information processing device 100 improves the utilization efficiency of the AI device and improves the throughput of the inference processing in a case where the inference processing is executed using the AI device. However, these are not intended to limit the inference task used by the information processing device 100. Not limited to the image classification task and the object detection task, the information processing device 100 may execute an appropriate inference task in correspondence with data including an inference target and configuration data to be generated. The information processing device 100 may use the same type of task as inference of both the image and the configuration image. The description of the present example embodiment is not intended to limit data including a processing target of the information processing device 100 to images.

### Description of Configuration

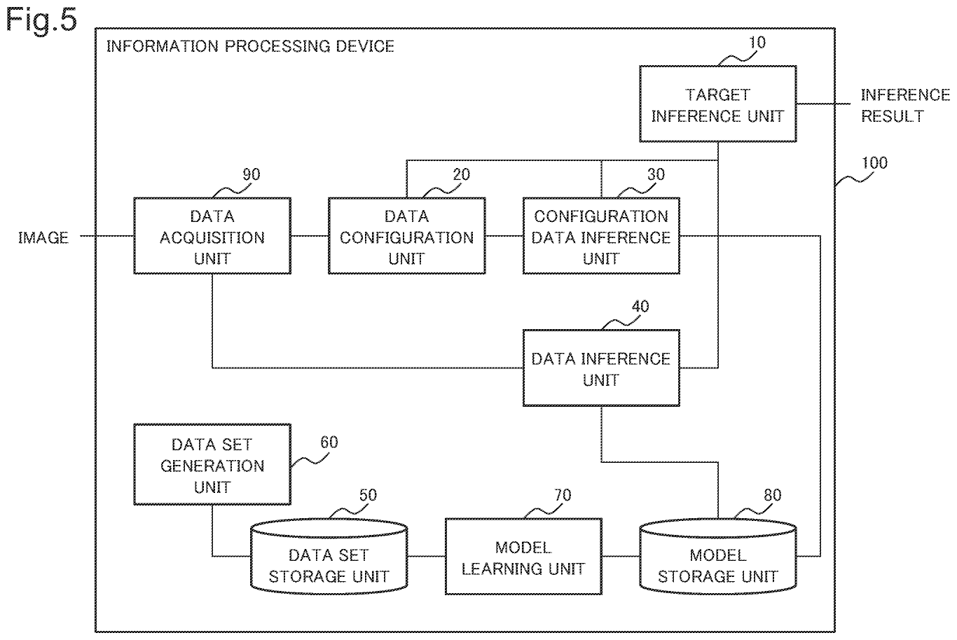

FIG. 5 is a block diagram illustrating an example of a configuration of the information processing device 100 according to the second example embodiment. The information processing device 100 includes a target inference unit 10, a data configuration unit 20, a configuration data inference unit 30, and a data inference unit 40. Furthermore, the information processing device 100 includes a data set storage unit 50, a data set generation unit 60, a model learning unit 70, a model storage unit 80, and a data acquisition unit 90. The number of components and the connection relationship illustrated in FIG. 5 are examples. For example, the information processing device 100 may include a plurality of data acquisition units 90. Alternatively, the information processing device 100 may include a plurality of sets of the target inference unit 10, the data configuration unit 20, the configuration data inference unit 30, and the data inference unit 40, and execute an operation described below in each set in parallel to execute inference on a target included in a plurality of images in parallel.

The information processing device 100 may be configured using a computer device including a CPU, an AI device, a main memory, and a secondary storage device. In this case, the components of the information processing device 100 illustrated in FIG. 5 are implemented by using a combination of hardware and software such as a CPU. Then, in this case, the information processing device 100 uses the AI device in all or a part of the inference processing described below. The hardware configuration of the CPU and the like will be further described later.

In the information processing device 100, a configuration for controlling the operation of each component is arbitrary. For example, the information processing device 100 may include a control unit (not illustrated) that controls each component. Alternatively, a predetermined component may control the operation of all other components or some components. For example, the target inference unit 10 may control the operations of the data configuration unit 20, the configuration data inference unit 30, and the data inference unit 40 to infer the class of characters in the image. Alternatively, each component may begin operation when acquiring data from other components. Therefore, in the following description, the description regarding the control of the operation of the component is omitted unless otherwise necessary.

### (1) Data Configuration Unit 20

The data configuration unit 20 acquires an image at least a portion of which includes an inference target from the data acquisition unit 90. Then, the data configuration unit 20 generates a configuration image that is an image suitable for inference by the configuration data inference unit 30, using a plurality of acquired images. The data configuration unit 20 is an example of the data configuration unit 21. In the following description, specifically, the data configuration unit 20 combines the plurality of images acquired from the data acquisition unit 90 to generate a configuration image having a larger size than the acquired image. Then, the data configuration unit 20 generates a correspondence between the image used to generate the configuration image and the position of the image in the configuration image. Alternatively, the data configuration unit 20 may generate a correspondence between the image used to generate the configuration image and the position of the region where the image is duplicated in the configuration image.

In the operation of the information processing device 100 in the following description, the operations related to the above two correspondence are substantially similar operations. Therefore, in the following description, in order to avoid complication of the description, the “correspondence between the image and the position of the image in the configuration image” includes the “correspondence between the image and the position of the region of the configuration image to duplicate the image”. That is, in the operation related to the following correspondence, the information processing device 100 may use the “position of the region in the configuration image” instead of the “position of the image in the configuration image” in the operation related to the “correspondence between the image and the position of the image in the configuration image”.

The image acquired by the data configuration unit 20 may include an inference target at least a portion there. In other words, a part of the image acquired by the data configuration unit 20 may not include the inference target. For example, in a case where the inference target is a character included in an image, a part of the image acquired by the data configuration unit 20 may be an image that does not include the character to be inferred, or may be an image in which a part of the character is missing.

Next, an example of generation of a configuration image in the data configuration unit 20 will be described. However, the generation of the configuration image in the data configuration unit 20 is not limited to the following. The data configuration unit 20 divides the region of the configuration image into a plurality of grid-like regions based on at least some following parameters.

Examples of parameters:
(a) The size of the configuration image, that is, the size in the longitudinal direction and the lateral direction, or the size in the width and the height.
(b) The number of grids in the lateral direction and the number of grids in the longitudinal direction.
(c) The gap of the regions, i.e. the length of the gap between the regions. The length of the gap may be different between the longitudinal direction and the lateral direction.
(d) A pixel value that fills a gap between regions. The pixel value is black, white, gray, random, or the like.

For example, in a case where the number of regions in the longitudinal direction and the lateral direction of the configuration image is used as the parameter, the data configuration unit 20 divides the configuration image into the number of regions in the longitudinal direction and the lateral direction acquired as the parameter. For example, in a case where the number in the longitudinal direction is 3 and the number in the lateral direction is 4, the data configuration unit 20 divides the configuration image into 12 (=3×4) regions. The data configuration unit 20 acquires these parameters from an operator or the like.

Then, the data configuration unit 20 duplicates each acquired image in each of the divided regions to generate a configuration image. In a case where the size of the region in the configuration image does not match the size of the image, the data configuration unit 20 may enlarge or reduce the image and duplicate the image in the region. At that time, the data configuration unit 20 may be deformed in such a way to maintain the aspect ratio of the image, or may be enlarged or reduced independently in the lateral direction and the longitudinal direction. Alternatively, the data configuration unit 20 may store a plurality of sets of parameters, switch the sets of parameters according to the characteristics of the image, and generate the configuration image from the image. For example, the data configuration unit 20 may select a parameter used for generating the configuration image in such a way that the amount of enlargement and reduction of the image is minimized. However, the data configuration unit 20 may duplicate the image in the region without deforming the image.

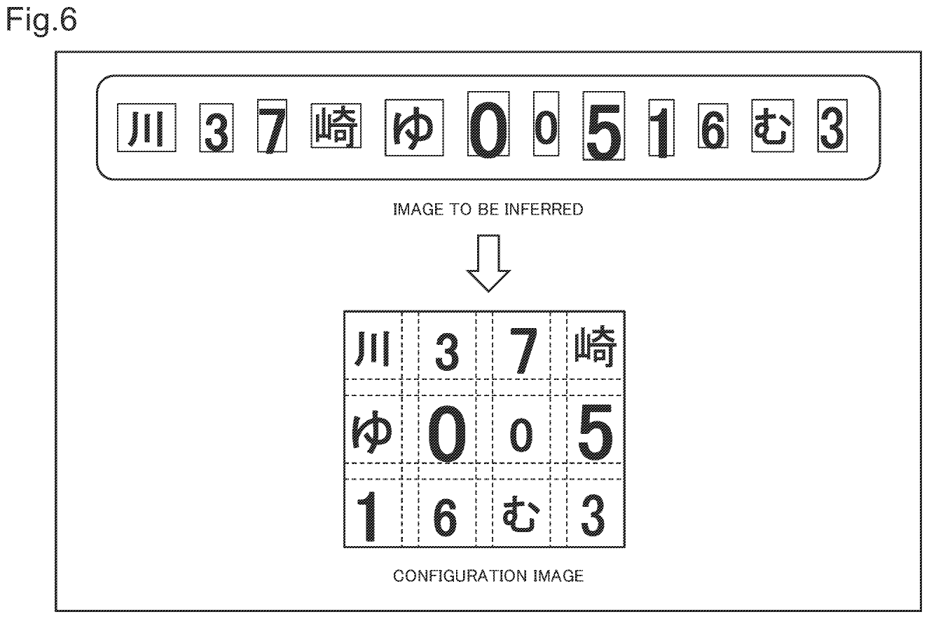

FIG. 6 is a diagram illustrating an example of a configuration image generated by the data configuration unit 20. An upper part of FIG. 6 is an image acquired by the data configuration unit 20, that is, images to be inferred. The lower part of FIG. 6 is a configuration image generated by the data configuration unit 20. In the configuration image in the lower part of FIG. 6, a region divided by a dotted line in which the image is duplicated is a region in which the image is duplicated. The other portion is a gap region between the regions. In FIG. 6, the data configuration unit 20 divides the region of the configuration image into four regions in the lateral direction and into three regions in the longitudinal direction as a grid of the configuration image. Further, the data configuration unit 20 uses “white” as the pixel value of the gap filling the space between the images. Then, the data configuration unit 20 duplicates the image from the left region to the right region in each of the upper region to the lower region of the configuration image from the left image of the image to be inferred. However, the position and order of duplicating the image in the configuration image are not limited thereto. The dotted line in the configuration image in the lower part of FIG. 6 is provided for description and is not included in the actually generated configuration image.

The data configuration unit 20 may generate the configuration image by combining the images based on the channel instead of duplicating the images in the planar direction. The channel in the image is a mechanism for handling various information in the image as a grayscale image. Alternatively, the data configuration unit 20 may generate the configuration image by combining the planar direction and the channel direction.

### (2) Configuration Data Inference Unit 30

The configuration data inference unit 30 uses the configuration image generated by the data configuration unit 20 as an input to infer the position and class of the character in the configuration image. The configuration data inference unit 30 is an example of the configuration data inference unit 31. In the following description, specifically, the configuration data inference unit 30 infers the position and class of the character in the configuration image using the object detection task. In the inference, the configuration data inference unit 30 uses the trained model stored in the model storage unit 80. Hereinafter, the trained model used by the configuration data inference unit 30 may be referred to as a “configuration data inference model”. The configuration data inference unit 30 may execute the inference after changing at least one of the shape and the size of the configuration image.

### (3) Data Inference Unit 40

The data inference unit 40 uses at least a portion of the image acquired by the data acquisition unit 90 as an input to infer the class of characters in the image. The data inference unit 40 is an example of the data inference unit 41. Specifically, the data inference unit 40 infers the class of characters included in the image using the image classification task. The data inference unit 40 uses the trained model stored in the model storage unit 80 in inference. Hereinafter, the trained model used by the data inference unit 40 may be referred to as a “data inference model”. The data inference unit 40 performs inference on the image on which an instruction is given. For example, the data inference unit 40 may execute inference on an image on which an instruction is given from the target inference unit 10. The target inference unit 10 may instruct the data acquisition unit 90 on an image to be output to the data inference unit 40. In this case, the data inference unit 40 may perform inference on all the images acquired from the data acquisition unit 90. The data inference unit 40 may execute inference after changing at least one of the shape and the size of the image.

In the description of the second example embodiment, the inference as the information processing device 100 is inference of the class of characters included in an image. That is, in the description of the second example embodiment, the inference of the data inference unit 40 is the same as the inference as the information processing device 100. However, the inference of the data inference unit 40 may be different from the inference as the information processing device 100 as long as an inference result similar to the inference as the information processing device 100 is output.

A difference in inference between the configuration data inference unit 30 and the data inference unit 40 will be described. The configuration image is an image obtained by combining the images acquired by the data acquisition unit 90, and is an image having a larger size than the image acquired by the data acquisition unit 90. That is, the configuration image to be inferred by the configuration data inference unit 30 is an image larger in size than the image to be inferred by the data inference unit 40. Furthermore, the object detection task used by the configuration data inference unit 30 is an inference task that is highly likely to execute inference processing having higher parallelism than the image classification task used by the data inference unit 40. Therefore, the configuration data inference unit 30 can efficiently use a plurality of arithmetic units in the AI device from the data inference unit 40.

As described above, the trained model used by the configuration data inference unit 30 is a model for an image having a larger size than the trained model used by the data inference unit 40. Therefore, the trained model used by the configuration data inference unit 30 is a model having a larger scale than the trained model used by the data inference unit 40. The trained model used by the configuration data inference unit 30 may be a model in which at least one of the model structure and the network structure is the same as the trained model used by the data inference unit 40. However, the trained model used by the configuration data inference unit 30 may be a model in which both the model structure and the network structure are different from the trained model used by the data inference unit 40.

### (4) Target Inference Unit 10

The target inference unit 10 performs inference on a target in the image acquired by the data acquisition unit 90. The target inference unit 10 is an example of the target inference unit 11. Specifically, first, the target inference unit 10 determines, for each image included in the configuration image, whether the inference on the target included in the image constituting the configuration image in the configuration data inference unit 30 has succeeded or failed. In a case of an image for which inference on a target included in an image constituting a configuration image in the configuration data inference unit 30 has succeeded, the target inference unit 10 infers the class of characters of the image based on an inference result in the configuration data inference unit 30 and the configuration image.

Specifically, the target inference unit 10 infers the class of characters included in the image using the following information.
(a) A position and a class of a character that is an inference result of the configuration data inference unit 30, and
(b) A correspondence between the image used to generate the configuration image and the position of the image in the configuration image, which is generated by the data configuration unit 20.

For example, the target inference unit 10 extracts the position of the image including the position of the character inferred by the configuration data inference unit 30 among the positions of the images in the configuration image. Then, the target inference unit 10 specifies an image relevant to the position of the extracted image, that is, an image used to generate the configuration image based on the correspondence between the image used to generate the configuration image and the position of the image in the configuration image. Then, the target inference unit 10 infers the class of characters inferred by the configuration data inference unit 30 as the class of characters of the specified image. Then, the target inference unit 10 outputs an inference result.

In a case of an image in which inference on a target included in an image constituting a configuration image in the configuration data inference unit 30 has failed, the target inference unit 10 instructs the data inference unit 40 to perform inference on the target included in the image, and acquires an inference result from the data inference unit 40. Then, the target inference unit 10 infers the class of characters which is the inference result in the data inference unit 40 as the class of characters in the image. Then, the target inference unit 10 outputs an inference result. The image acquired by the data configuration unit 20 may be an image that does not include characters to be inferred. Therefore, in a case where the inference in the data inference unit 40 has failed, the target inference unit 10 may output an inference result with an image that does not include characters as the result of performing the inference on the target included in the image. Alternatively, the target inference unit 10 may output “that the inference on the target included in the image has failed” as a result of the inference.

Next, determination of whether the inference of the configuration data inference unit 30 is succeed or failed in the target inference unit 10 will be described. In the description of the present example embodiment, the target inference unit 10 determines whether the inference in the configuration data inference unit 30 has succeeded or failed using the position of the character inferred in the configuration image. Details are as follows. The configuration data inference unit 30 infers the position of the BB relevant to the character as the position of the character. Then, the target inference unit 10 determines whether the inference has succeeded or failed based on the position of the BB and the position of the image duplicated in the configuration image generated by the data configuration unit 20. For example, the target inference unit 10 determines an image including the BB from which the position of the image constituting the configuration image has been inferred as an image for which inference has succeeded. The image including the BB includes an image that matches the BB, that is, an image having the same shape as the BB, in addition to the image including the BB inside. Alternatively, the target inference unit 10 may determine an image in which a deviation between the position of the image constituting the configuration image and the position of the BB is within a predetermined range as a successful image in consideration of an error in inference. On the other hand, the target inference unit 10 determines an image in which the BB is not inferred at the position of the image constituting the configuration image and an image in which a part of the BB is not included at the position of the image constituting the configuration image as an image for which inference has failed.

However, the determination in the target inference unit 10 is not limited to the relationship between the position of the image and the position of the BB in the configuration image described above. For example, the target inference unit 10 may use the confidence of inference in the configuration data inference unit 30. Alternatively, the target inference unit 10 may determine whether the inference of the configuration data inference unit 30 has succeeded or failed using an intersection over union (IoU) between the image in the configuration image and the BB. The IoU is one of evaluation indices in object detection, and is an index indicating how much two regions overlap. Specifically, the IoU is a ratio of a common portion (intersection) of two regions to a union of the two regions. For example, the target inference unit 10 may determine an image in which the IoU between the region of the image and the region of the BB in the configuration image is higher than a predetermined threshold as an image for which the inference has succeeded. However, the target inference unit 10 may determine whether the inference of the configuration data inference unit 30 has succeeded or failed using a determination criterion different from the above.

### (5) Data Set Generation Unit

The data set generation unit 60 generates a learning data set used for machine learning for generating a trained model, using a predetermined data set. Specifically, the data set generation unit 60 generates a learning data set for machine learning that generates a configuration data inference model used for inference in the configuration data inference unit 30. Hereinafter, the learning data set for generating the configuration data inference model may be referred to as a “configuration data learning data set”. Furthermore, the data set generation unit 60 generates a learning data set for machine learning that generates a data inference model used for inference in the data inference unit 40. Hereinafter, the learning data set for generating the data inference model may be referred to as a “data learning data set”.

In the following description, the data set used by the data set generation unit 60 to generate the learning data set may be referred to as an “original data set”. For example, the data set generation unit 60 may generate each learning data set using the original data set acquired from the user. However, the acquisition source of the original data set is not limited to the above. For example, the data set generation unit 60 may generate each learning data set using an original data set stored in the data set storage unit 50 in advance. The data set generation unit 60 may generate both the configuration data learning data set and the data learning data set using the same original data set. Alternatively, the data set generation unit 60 may generate the configuration data learning data set and the data learning data set using different original data sets.

In the case of generating the configuration data learning data set, the data set generation unit 60 may generate the configuration image from the image included in the original data set. In this case, the data set generation unit 60 may generate the configuration image from the image included in the original data set using the same operation as the generation of the configuration image in the data configuration unit 20. The data set generation unit 60 may generate correct answer data for the generated configuration image by using information regarding the position of the image in the configuration image or the like. For example, in a case where the configuration data inference unit 30 uses an object detection task, the data set generation unit 60 may create the following data as correct answer data for the configuration image for each image used to generate the configuration image using a predetermined object detection task.
(a) BB: a position of a character included in an image in a configuration image generated from the original data set, and
(b) Class: a class of characters included in an image in a configuration image generated from an original data set.

The data set generation unit 60 may estimate the class of the image included in the original data set using a predetermined image classification task as the class of the correct answer data.

A method of generating correct answer data may be referred to as annotation. The annotation is generally to add information related to metadata or the like to certain data as an annotation, but in the field of machine learning, it is to create learning data, correct answer data, a label, and the like for causing a model of machine learning to learn. For example, the role of the annotation is to make data such as an image distinctive or associated, and to combine the data with each other. The learning data set may also be referred to as “training data”.

### (6) Data Set Storage Unit

The data set storage unit 50 stores the learning data set generated by the data set generation unit 60. For example, in a case where the configuration data inference unit 30 uses the trained model of the object detection task, the data set storage unit 50 stores a configuration data learning data set including an image to be subjected to object detection and correct answer data such as the BB and a class in the image. Alternatively, in a case where the data inference unit 40 uses the trained model of the image classification task, the data set storage unit 50 stores a data learning data set including an image to be classified and correct answer data such as a class.

### (7) Model Learning Unit

The model learning unit 70 generates a trained model used by the configuration data inference unit 30 and the data inference unit 40. Specifically, the model learning unit 70 generates the configuration data inference model used by the configuration data inference unit 30 by machine learning using the configuration data learning data set stored in the data set storage unit 50. Further, the model learning unit 70 generates a data inference model to be used by the data inference unit 40 by machine learning using the data learning data set stored in the data set storage unit 50. Then, the model learning unit 70 stores the generated trained model in the model storage unit 80.

### (8) Model Storage Unit

The model storage unit 80 stores the trained model which is generated by the model learning unit 70 and used for inference by the configuration data inference unit 30, that is, the configuration data inference model. Further, the model storage unit 80 stores the trained model which is generated by the model learning unit 70 and used for inference by the data inference unit 40, that is, the data inference model.

### (9) Data Acquisition Unit

The data acquisition unit 90 acquires an image including an inference target of the information processing device 100. The data acquisition unit 90 acquires an image from a monitoring camera, for example. Alternatively, the data acquisition unit 90 may acquire an image from a storage device (not illustrated) that stores an image including an inference target. The data acquisition unit 90 may be included in a device that acquires an image, such as a monitoring camera.

### Description of Operation

An operation of generating a trained model and an operation of executing inference on a target in the information processing device 100 according to the second example embodiment will be described with reference to the drawings.

### (1) Operation of Generating Trained Model

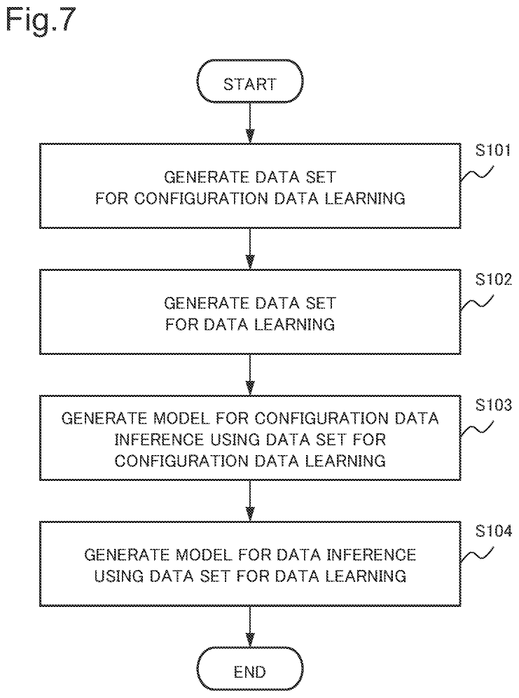

FIG. 7 is a flowchart illustrating an example of an operation of generating a trained model in the information processing device 100 according to the second example embodiment. The information processing device 100 starts operation in response to a predetermined condition. For example, the information processing device 100 starts the operation of generating a trained model in response to an instruction from the operator of the information processing device 100. In this case, at the start of the operation, the information processing device 100 may acquire parameters necessary for generating a trained model from the operator. The parameter is, for example, a parameter related to designation of a learning data set to be used for generation of a model or machine learning. However, the parameter is not limited thereto, and may be other information. The information processing device 100 may acquire information different from the parameter. For example, the information processing device 100 may acquire the original data set, the correct answer data, or the learning data set from the operator. In this case, the information processing device 100 may store the acquired original data set, correct answer data, or learning data set in the data set storage unit 50. The correct answer data may be included in the learning data set.

The data set generation unit 60 acquires the original data set from the data set storage unit 50, and generates the configuration data learning data set using the acquired original data set (step S101). The data set generation unit 60 may acquire correct answer data of the configuration data learning data set from the data set storage unit 50. Then, the data set generation unit 60 stores the generated configuration data learning data set in the data set storage unit 50. Furthermore, the data set generation unit 60 acquires the original data set from the data set storage unit 50, and generates a data learning data set using the acquired original data set (step S102). Also in this case, the data set generation unit 60 may acquire correct answer data of the data learning data set from the data set storage unit 50. Then, the data set generation unit 60 stores the generated data learning data set in the data set storage unit 50. The data set generation unit 60 may execute the operations in steps S101 and S102 by changing the order of the operations, or may execute at least some operations in parallel.

The model learning unit 70 generates a configuration data inference model by machine learning using the configuration data learning data set (step S103). The configuration data inference model is a trained model used by the configuration data inference unit 30. The model learning unit 70 stores the generated configuration data inference model in the model storage unit 80. Furthermore, the model learning unit 70 generates the data inference model by machine learning using the data learning data set (step S104). The data inference model is a trained model used by the data inference unit 40. The model learning unit 70 stores the generated data inference model in the model storage unit 80. The model learning unit 70 may execute the operations in the order of steps S103 and S104, or may execute at least some operations in parallel. After completion of the operation of generating the model, the information processing device 100 may notify the operator of the operation result.

### (B) Operation of Executing Inference on Target

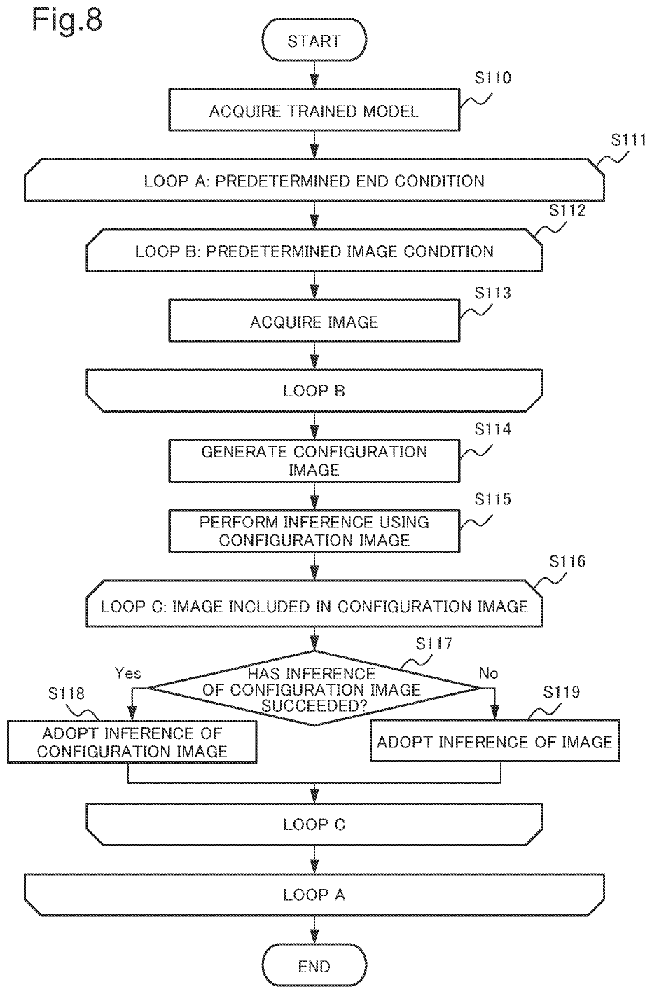

FIG. 8 is a flowchart illustrating an example of an operation of executing inference on a target in the information processing device 100 according to the second example embodiment. The information processing device 100 starts the inference operation in response to a predetermined condition. For example, the information processing device 100 starts the inference operation in response to an instruction from the operator. Alternatively, the information processing device 100 may automatically start the inference operation after activation of the device. The information processing device 100 may acquire parameters relating to the inference operation from the operator at the start of the inference operation. The parameter is, for example, designation of a trained model to be used, but is not limited thereto. However, the information processing device 100 may use a parameter acquired in advance. In a case where the used trained model is not stored at the start of the inference operation, the information processing device 100 may start the inference operation after executing the above-described “(A) Operation of Generating Trained Model” to generate a trained model to be used.

The configuration data inference unit 30 and the data inference unit 40 acquire a trained model used for inference from the model storage unit 80 (step S110). Then, the information processing device 100 repeats the operation of the loop A until a predetermined end condition is satisfied (step S111). An example of the end condition is an end instruction from the operator. However, the information processing device 100 may end the operation of the loop A based on other end conditions such as the operation time or the number of images.

In the loop A, first, the data configuration unit 20 repeats the operation of the loop B until a predetermined image condition is satisfied (step S112). An example of the image condition is the number of images. That is, the data configuration unit 20 repeats the operation of the loop B until the number of images reaches a predetermined number. However, the data configuration unit 20 may end the loop B based on other image conditions such as the total area of the acquired images or the total data amount of the acquired images. In the loop B, the data configuration unit 20 acquires an image to be used for generating a configuration image from the data acquisition unit 90 (step S113). In the following description, images acquired by the operation of one loop B will be collectively referred to as a “configuration target images”.

When the image condition is satisfied, the data configuration unit 20 generates a configuration image from the acquired configuration target images (step S114). For example, the data configuration unit 20 generates a configuration image by duplicating an image of the configuration target images in a region of configuration images arranged in a grid pattern. Next, the configuration data inference unit 30 uses the generated configuration image as an input and performs inference (step S115). For example, the configuration data inference unit 30 infers a set of the class of characters, the BB, and the confidence included in the configuration image using the trained model of the object detection task.

Then, the target inference unit 10 repeats the operation of the loop C for all the images duplicated in the configuration image, that is, all the images included in the configuration target images (step S116). In the loop C, the target inference unit 10 determines whether the inference of the configuration data inference unit 30 has succeeded or failed for each image of the configuration target images in the configuration image (step S117). For example, the target inference unit 10 compares the position of the image in the configuration image with the position of the BB in the inference result of the configuration data inference unit 30, and determines whether the inference has succeeded or failed.

In a case of an image for which inference in the configuration image has succeeded (Yes in step S117), the target inference unit 10 adopts the result of performing the inference on the target included in the configuration image as the result of performing the inference on the target included in the image (step S118). For example, in a case where the information processing device 100 executes the image classification task and the configuration data inference unit 30 executes the object detection task, the target inference unit 10 adopts the class and the confidence included in the inference result of the configuration data inference unit 30 as the result of performing the inference on the target included in the image. In a case of an image in which inference on a target included in the configuration image has failed (No in step S117), the target inference unit 10 instructs the data inference unit 40 to perform inference on the target included in the image. The data inference unit 40 performs inference on a target included in the image. Then, the target inference unit 10 adopts the result of performing the inference on the target included in the image as the result of performing the inference on the target included in the image (step S119). Using such an operation, the information processing device 100 performs inference on the target included in the image acquired by the data acquisition unit 90.

### Description of Throughput

Next, an example of comparison between the throughput in the information processing device 100 according to the second example embodiment and the throughput in a case where only the image classification task is used will be described. Hereinafter, a case where only the image classification task is used is referred to as a “comparison technique”. The premise in the following description is as follows. The load of processing other than the inference processing is smaller than that of the inference processing, and thus will be ignored in the following description. The unit of throughput is fps.

### Processing Amount

The size of the image to be inferred by the comparison technique and the data inference unit 40 is 64×64 pixels. The size of the configuration image to be inferred by the configuration data inference unit 30 is 512×512 pixels. It is assumed that the increment of the processing amount of the object detection task with respect to the image classification task in a case where the feature extraction layers are the same is 1.2 times. At this time, the processing amount of the configuration data inference unit 30 is (512×512)/(64×64)×1.2=76.8 times the comparison technique and the data inference unit 40.

### Utilization Efficiency of AI Device

The utilization efficiency of the AI device in the case of using the image is set to 10%. The utilization efficiency of the AI device in a case where the configuration image is used is 70%. That is, the utilization efficiency of the AI device in the configuration data inference unit 30 is 70/10=7 times that of the comparison technique.

### Configuration Image

The number of areas in which the image is duplicated in the configuration image is 7×7. That is, the configuration image is an image obtained by duplicating 49 images.

### Variable

The variables included in the expression used for the description are as follows.
CPS_{comp}: Throughput [unit: character per second (cps)] of the AI device in units of images in the inference of the comparison technique and the data inference unit 40,
FPSₘₐₓ: Maximum throughput [unit: fps] of the AI device in units of configuration images in the inference of the configuration data inference unit 30,
CPSₘₐₓ: Maximum throughput [unit: cps] of the AI device in units of images in the inference of the configuration data inference unit 30,
CPS_{10%failure}: Throughput of the AI device in units of images in a case where inference of the configuration data inference unit 30 has failed by 10% [unit: cps].

In this case, FPSₘₐₓ and CP_{Smax} are

$${FPS}_{max} = ( {CPS}_{comp} / ( ( ( 512 \times 512 ) / ( 64 \times 64 ) ) \times 1.2 ) ) \times ( 70 / 10 ) = ( {CPS}_{comp} / 76.8 ) \times 7 \approx 0.091 \times {CPS}_{comp} , and$$

$${CPS}_{max} = {FPS}_{max} \times 49 = 0.091 \times {CPS}_{comp} \times 49 \approx 4.46 \times {CPS}_{comp} .$$

That is, the throughput CPSₘₐₓ in a case where the configuration data inference unit 30 has succeeded in inference on the target included in all the configuration images is about 4.46 times the throughput CPS_{comp} of the comparison technique. CPSₘₐₓ is the maximum throughput of the information processing device 100.

The throughput CPS_{10%failure} in a case where the inference of the configuration data inference unit 30 has failed by 10% is as follows. First, the processing time of the configuration data inference unit 30 and the processing time of the data inference unit 40 are

Processing time of the configuration data inference unit 30:

$$N / ( {CPS}_{max} ) \approx N / ( 4.46 \times {CPS}_{comp} ) ,$$

Processing time of the data inference unit 40: 0.1×N/CPS_{comp}. N is the number of images to be processed. From the total of the processing time of the configuration data inference unit 30 and the processing time of the data inference unit 40 and the number of images (N), the throughput CPS_{10%failure} in this case can be calculated as:

$${CPS}_{10 \% failure} = N / ( N / ( 4.46 \times {CPS}_{comp} ) + 0.1 \times N / {CPS}_{comp} ) = {CPS}_{comp} / ( 1 / 4.46 + 0.1 ) \approx 3.08 \times {CPS}_{comp} .$$

That is, even in a case where the inference of the configuration data inference unit 30 has failed by 10%, the throughput of the information processing device 100 is about 3.08 times the throughput of the comparison technique.

In this manner, the information processing device 100 improves the throughput of the inference processing. The reason is as follows. The information processing device 100 includes a target inference unit 10, a data configuration unit 20, a configuration data inference unit 30, and a data inference unit 40. The data configuration unit 20 generates configuration data configured using a plurality of pieces of data, at least a portion of which includes an inference target. The configuration data inference unit 30 performs inference on a target included in the configuration data. The data inference unit 40 performs inference on a target included in at least a portion of data. The target inference unit 10 determines whether inference for a target included in the configuration data has succeeded or failed for each piece of data constituting the configuration data. Then, the target inference unit 10 performs inference on the target based on the result of performing the inference on the target included in the configuration data and the configuration data as inference on the target included in the data for which inference on the target included in the configuration data has succeeded. Then, the target inference unit 10 performs inference on the target based on the result of performing the inference on the target included in the data as inference on the target included in the data for which inference on the target included in the configuration data has failed.

The information processing device 100 performs inference using configuration data that is data larger in scale than data, and improves the throughput of inference processing. In particular, in a case of using hardware that achieves a high throughput by operating a large number of arithmetic units such as AI devices in parallel, the information processing device 100 can improve the throughput of inference processing. For example, in the above description of the throughput, the maximum throughput of the information processing device 100 is about 4.46 times the throughput of the comparison technique.

Furthermore, the target inference unit 10 performs inference on the target using the inference result of the data inference unit 40 for the data for which inference on the target has failed. The inference in the data inference unit 40 is an inference having lower parallelism than the inference in the configuration data inference unit 30. However, the data inference unit 40 performs inference on data smaller in scale than the configuration data by using a model smaller in scale than the configuration data inference unit 30. Therefore, the inference of the data inference unit 40 is an inference with a lower load than the inference in the configuration data inference unit 30. In a case where the failure probability in the configuration data inference unit 30 is low, the quantity of data inferred by the data inference unit 40 is considerably smaller than the quantity of data to be inferred. Therefore, in this case, the information processing device 100 can suppress the influence on the performance for the entire inference to be small even if the data inference unit 40 is used.

The data inferred by the data inference unit 40 is data for which the configuration data inference unit 30 has failed in inference. Therefore, in a case where the configuration data inference unit 30 performs inference on a target included in the data again, it is assumed that the possibility of failure is high. On the other hand, inference using the data inference unit 40 is assumed to have a lower possibility of inference failure than the case of inference using the configuration data inference unit 30 again. As a result, the information processing device 100 can reduce the performance degradation with respect to the entire processing based on the failure of the re-inference in the configuration data inference unit 30 by performing the inference using the data inference unit 40.

As described above, the information processing device 100 improves reduction in throughput using the data inference unit 40 even in a case where there is data for which inference is not successful in the configuration data inference unit 30. For example, in the above described example, even in a case where the inference of the configuration data inference unit 30 has failed by 10%, the throughput of the information processing device 100 is about 3.08 times the throughput of the comparison technique.

Furthermore, the information processing device 100 may include a data set generation unit 60, a data set storage unit 50, a model learning unit 70, a model storage unit 80, and a data acquisition unit 90. The data set generation unit 60 generates a configuration data learning data set for generating a configuration data inference model using a predetermined data set. Furthermore, the data set generation unit 60 generates a data learning data set for generating a data inference model using a predetermined data set. The data set storage unit 50 stores the configuration data learning data set and the data learning data set. The model learning unit 70 generates a configuration data inference model by machine learning using the configuration data learning data set. Furthermore, the model learning unit 70 generates a data inference model by machine learning using the data learning data set. The model storage unit 80 stores a configuration data inference model and a data inference model. The data acquisition unit 90 acquires data. Then, the data configuration unit 20 generates configuration data constituting the data acquired from the data acquisition unit 90. The configuration data inference unit 30 performs inference on a target included in the configuration data using the configuration data inference model stored in the model storage unit 80. The data inference unit 40 acquires data on which an instruction is given by the target inference unit 10 from the data acquisition unit 90, and infers a target included in the acquired data using the data inference model stored in the model storage unit 80. Based on such a configuration, the information processing device 100 generates a model used for inference, and uses the generated model to execute inference on a target included in data acquired by the data acquisition unit 90.

The information processing device 100 may use two-dimensional data such as an image as the data. For example, in a case where the data is an image, the data configuration unit 20 may generate a configuration image in which a plurality of images are arranged on a two-dimensional plane. In this case, the configuration data inference unit 30 may execute an object detection task as inference on a target included in the configuration image. Furthermore, in this case, the data inference unit 40 may execute an image classification task as inference on a target included in an image. The configuration image includes a plurality of images. Furthermore, the object detection task is likely to execute processing having higher parallelism than the image classification task as inference processing for a target included in a plurality of images. Therefore, the information processing device 100 improves the throughput of the inference processing.

### Variations

The data set storage unit 50 may store a learning data set given in advance from a user or the like as at least a portion of the learning data set. Alternatively, the information processing device 100 may acquire a learning data set generated in another device (not illustrated) as at least some learning data set and store the learning data set in the data set storage unit 50. In a case where the information processing device 100 acquires all the learning data sets and stores the learning data sets in the data set storage unit 50, the information processing device 100 may not include the data set generation unit 60.

The model learning unit 70 may acquire at least some learning data sets from a device (not illustrated). In a case where the model learning unit 70 acquires all the learning data sets from a device (not illustrated), the information processing device 100 may not include the data set storage unit 50 and the data set generation unit 60.

The model storage unit 80 may store the trained model acquired from the user. Alternatively, the information processing device 100 may acquire a trained model generated by a device (not illustrated) and store the trained model in the model storage unit 80. In a case where the information processing device 100 acquires all the trained models and stores the trained models in the model storage unit 80, the information processing device 100 may not include the data set storage unit 50, the data set generation unit 60, and the model learning unit 70.

At least one of the configuration data inference unit 30 and the data inference unit 40 may acquire the trained model to be used from another device. In a case where both the configuration data inference unit 30 and the data inference unit 40 acquire the trained model from an external device (not illustrated), the information processing device 100 may not include the data set storage unit 50, the data set generation unit 60, the model learning unit 70, and the model storage unit 80.

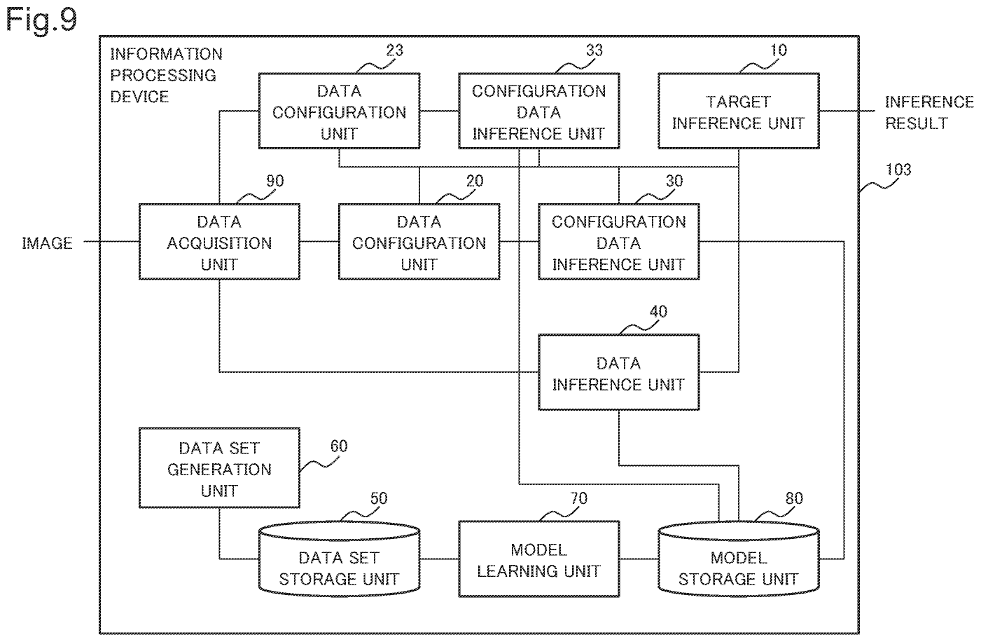

The information processing device 100 may include a plurality of sets of the data configuration unit 20 and the configuration data inference unit 30 as a set of the data configuration unit 20 and the configuration data inference unit 30. For example, the information processing device 100 may include two or more sets of the data configuration unit 20 and the configuration data inference unit 30. FIG. 9 is a block diagram illustrating a configuration of an information processing device 103 which is an example of a variation of the information processing device 100 according to the second example embodiment. The information processing device 103 includes a set of a data configuration unit 23 and a configuration data inference unit 33 in addition to the set of the data configuration unit 20 and the configuration data inference unit 30 which are configurations of the information processing device 100.

In the following description, when the pair of the data configuration unit 20 and the configuration data inference unit 30 and the pair of the data configuration unit 23 and the configuration data inference unit 33 are distinguished from each other, each pair may be referred to as follows.
A set of the data configuration unit 20 and the configuration data inference unit 30 is a first set, the data configuration unit 20 is a first data configuration unit, the configuration data inference unit 30 is a first configuration data inference unit, and the configuration data generated by the data configuration unit 20 is first configuration data.
A set of the data configuration unit 23 and the configuration data inference unit 33 is a second set, the data configuration unit 23 is a second data configuration unit, the configuration data inference unit 33 is a second configuration data inference unit, and the configuration data generated by the data configuration unit 23 is second configuration data.

Similarly to the data configuration unit 21, the data configuration unit 23 generates the second configuration data including a plurality of pieces of data by using a plurality of pieces of data. For example, in a case where the data is an image, the data configuration unit 23 combines a plurality of images to generate a second configuration image. However, the data configuration unit 23 generates the second configuration data using the data for which inference on the target included in the configuration data in the configuration data inference unit 30 has failed as the data for generating the second configuration data. The configuration data inference unit 33 performs inference on a target included in the second configuration data generated by the data configuration unit 23. The target inference unit 10 determines whether inference for a target included in the second configuration data has succeeded or failed for each piece of data constituting the second configuration data. Then, the target inference unit 10 performs inference on the target based on the result of performing the inference on the target included in the second configuration data and the second configuration data as inference on the target included in the data for which inference on the target included in the second configuration data has succeeded. Further, the target inference unit 10 instructs the data inference unit 40 to perform inference on the target included in the data for the data for which inference on the target included in the second configuration data has failed. Then, the target inference unit 10 performs inference on the target included in the data based on the result of performing the inference on the target included in the data as inference on the target included in the data for which inference on the target included in the second configuration data has failed.

The second configuration data includes data for which the configuration data inference unit 30 has failed in inference. Therefore, in a case where the configuration data inference unit 33 performs inference on a target included in the second configuration data using the same model as the configuration data inference unit 30, there is a high possibility that the inference fails. Therefore, for example, the model used by the configuration data inference unit 33 is desirably a model different from the model used by the configuration data inference unit 30. Alternatively, the second configuration data generated by the data configuration unit 23 is desirably data in a format different from that of the configuration data generated by the data configuration unit 20. For example, in the case of the data image, the data configuration unit 23 may generate the second configuration data in which the gap between the images is wider than that of the configuration data generated by the data configuration unit 20, or may generate the second configuration data after increasing the size of the duplicated image.

In a case where a plurality of sets of the data configuration unit 20 and the configuration data inference unit 30 are included, the information processing device 100 may use the plurality of sets in parallel instead of using the plurality of sets in series as described above. For example, the target inference unit 10 may allocate the data acquired by the data acquisition unit 90 into any of a plurality of sets. For example, the target inference unit 10 may allocate data to each set according to the round robin method. Alternatively, for example, in a case where the inference method or model in the configuration data inference unit 30 is different in each set, the information processing device 100 may allocate the data to a set suitable for inference on the target included in the data based on the attribute of the data such as the size. The data acquisition unit 90 may generate metadata regarding the acquired data, such as an attribute of the data. In this case, the information processing device 100 may use the generated metadata to allocate the data.

In a case where the plurality of sets of the data configuration unit 20 and the configuration data inference unit 30 are used in parallel, the information processing device 100 may include the data inference unit 40 relevant to each set. However, in a case where the probability of failure of inference in the configuration data inference unit 30 is low, the information processing device 100 may include one data inference unit 40, and the data inference unit 40 may execute inference on a target included in an image for which all sets of the configuration data inference units 30 have failed. Alternatively, the information processing device 100 may include a smaller number of data inference units 40 than the number of sets, and allocate and cause the plurality of data inference units 40 to execute the inference on the target included in the image for which the configuration data inference unit 30 has failed.

In a case where a plurality of sets of the data configuration unit 20 and the configuration data inference unit 30 are used in parallel, the information processing device 100 may include the target inference unit 10 relevant to each set. However, since the inference processing of the target inference unit 10 is inference using the inference results of the configuration data inference unit 30 and the data inference unit 40, the load is lower than that of the inference processing of the configuration data inference unit 30 and the data inference unit 40. Therefore, the information processing device 100 may execute inference based on a plurality of sets of inference results of the configuration data inference unit 30 and the data inference unit 40 by using one target inference unit 10. Alternatively, the information processing device 100 may include the target inference unit 10 for each predetermined number of sets.

Although the degree of improvement in the throughput decreases, the information processing device 100 may include one set of the data configuration unit 20 and the configuration data inference unit 30, and may operate again with data for which inference has failed in the configuration data inference unit 30 as an input to the data configuration unit 20. In particular, in a case where the probability of the inference failure in the configuration data inference unit 30 is low, the information processing device 100 may repeat the operations of the data configuration unit 20 and the configuration data inference unit 30 again. That is, the information processing device 100 may repeat the operations of the data configuration unit 20 and the configuration data inference unit 30 up to a predetermined number of times with respect to the data for which inference has failed in the configuration data inference unit 30. However, in a case where configuration data including failed data is inferred using the same model, there is a high possibility that inference on a target included in the data will fail. Therefore, in a case where the operation is repeated for the same data, it is desirable that the information processing device 100 change at least one of the operation to the data configuration unit 20 and the operation to the configuration data inference unit 30. In this manner, the information processing device 100 may advance the inference while changing the operation of at least one of the data configuration unit 20 and the configuration data inference unit 30.

In the above description, an example has been described in which the information processing device 100 executes the image classification task as the inference processing, the configuration data inference unit 30 executes the object detection task, and the data inference unit 40 executes the image classification task. However, the second example embodiment is not limited thereto. The information processing device 100 may execute an inference task different from the image classification task. Alternatively, the configuration data inference unit 30 may execute an inference task different from the object detection task. Alternatively, the data inference unit 40 may execute an inference task different from the image classification task.

For example, the information processing device 100 may execute a re-identification task of calculating a numerical value available for discrimination or identification of a plurality of targets of the same type or the same class as the inference. The re-identification task is one of the object detection tasks, and is a task of distinguishing and identifying a plurality of targets belonging to the same category when there are the plurality of targets. In the case of the re-identification task, the information processing device 100 may omit the inference in the data inference unit 40. For example, in a case where the model of the re-identification task includes the feature extraction layer and the re-identification layer, the trained model used by the configuration data inference unit 30 has a configuration in which the class classification layer and the regression layer in the model of the object detection task in FIG. 4 are replaced with the re-identification layer.

In the description of the second example embodiment so far, as an example, the data configuration unit 20 of the information processing device 100 divides the region of the configuration image into a plurality of grid-like partial regions, and duplicates the image to each region. However, the operation of the data configuration unit 20 is not limited to this operation. For example, in a case where the configuration data inference unit 30 executes the object detection task, the data configuration unit 20 may generate the configuration image in consideration of the anchor setting in the trained model of the object detection task used by the configuration data inference unit 30. More specifically, the data configuration unit 20 may combine the images based on the relationship between the anchor and the receptive field in such a way to improve the inference accuracy with respect to the target included in the configuration image that is the input of the object detection task. The anchor is a method of performing object detection for each of a plurality of BBs having different predetermined aspect ratios, and increasing the number of targets that can be simultaneously detected. The receptive field is a processable region in each layer of the model.

For example, in a case where the data configuration unit 20 generates a configuration image by arranging images in a grid shape and the configuration data inference unit 30 executes an object detection task, the configuration data inference unit 30 may use an anchor setting suitable for inference on a target included in an image constituting the configuration image. For example, the trained model of the object detection task used by the configuration data inference unit 30 may be configured to use an anchor setting suitable for inference on a target included in each image included in the configuration image.

### Third Example Embodiment

An information processing device 102 according to the third example embodiment changes at least one of the parameter related to the inference processing and the inference operation according to the situation of the inference operation. The parameter related to the inference processing is not limited to the following, but is, for example, a parameter that designates a trained model used for inference. The operation of inference to be changed will be described in more detail later, but is, for example, whether to use the configuration data inference unit 30. Hereinafter, the third example embodiment will be described with reference to the drawings. In the drawings referred to in the description of the third example embodiment, the same configurations and operations as those of the second example embodiment are denoted by the same reference numerals, and detailed description thereof is omitted as appropriate. The information processing device 102 may include a plurality of sets of the data configuration unit 20 and the configuration data inference unit 30, similarly to the second example embodiment. However, in the following description, for convenience of description, the information processing device 102 includes one configuration.

### Description of Configuration

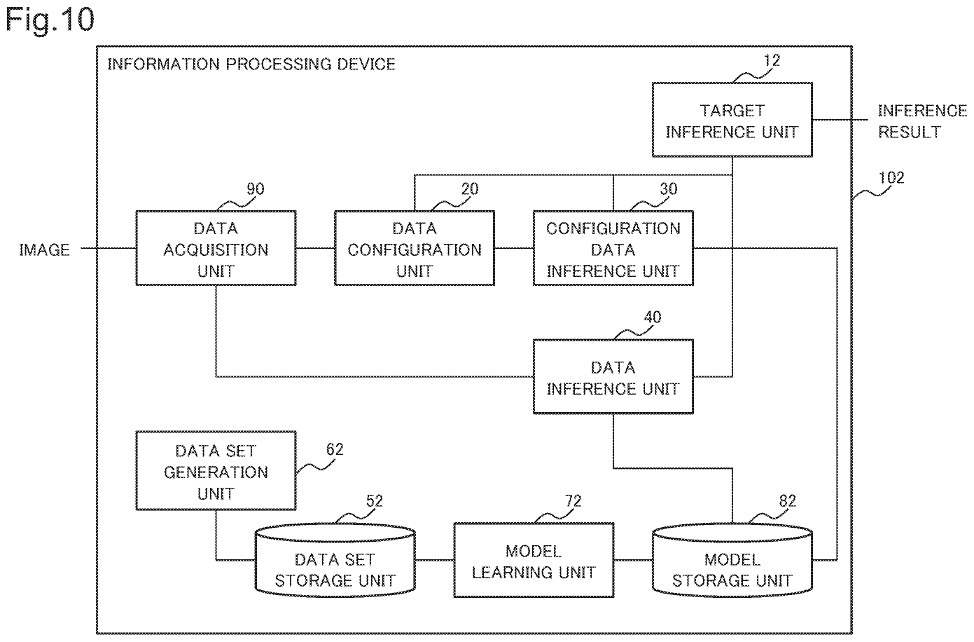

FIG. 10 is a block diagram illustrating an example of a configuration of the information processing device 102 according to the third example embodiment. The information processing device 102 may be configured using a computer device including a CPU and the like, similarly to the second example embodiment. The information processing device 102 includes a target inference unit 12, a data configuration unit 20, a configuration data inference unit 30, and a data inference unit 40. Furthermore, the information processing device 102 includes a data set storage unit 52, a data set generation unit 62, a model learning unit 72, a model storage unit 82, and a data acquisition unit 90.

In the information processing device 102, the configuration for controlling the operation of each component is arbitrary as in the second example embodiment. However, in the following description, for convenience of description, the target inference unit 12 changes the parameter and controls the operation of the data configuration unit 20 and the like. Since the data configuration unit 20, the configuration data inference unit 30, and the data inference unit 40 are similar to those of the second example embodiment except that the operation is changed according to the parameter changed by the target inference unit 12, detailed description thereof will be omitted. Since the data acquisition unit 90 is similar to that of the second example embodiment, a detailed description thereof will be omitted.

The target inference unit 12 operates similarly to the target inference unit 10 of the second example embodiment and performs inference on the target. Furthermore, the target inference unit 12 monitors the operation situation of the information processing device 102, changes the parameter regarding inference according to the operation status, and switches the operation such as inference. The operation situation is, for example, inference accuracy or an inference speed in at least one of the configuration data inference unit 30 and the data inference unit 40. However, the operation situation is not limited thereto. Next, as an example of the operation situation of the information processing device 102, an example in a case where the inference accuracy of the configuration data inference unit 30 falls below a predetermined threshold will be described. The target inference unit 12 may use accuracy used in general inference such as a reproduction rate (recall) as the inference accuracy of the configuration data inference unit 30.

In a case where the inference accuracy of the configuration data inference unit 30 falls below a predetermined threshold, the target inference unit 12 executes any one of the following operations or a combination of at least some operations. In a case where the inference accuracy in the configuration data inference unit 30 exceeds a predetermined threshold, the target inference unit 12 may execute an operation opposite to the operation described below.

(1) The target inference unit 12 temporarily stops the inference of the configuration data inference unit 30. That is, the target inference unit 12 uses the inference result of the data inference unit 40 without using the inference result of the configuration data inference unit 30 with low accuracy. While the configuration data inference unit 30 is stopped, the target inference unit 12 may stop the operation of the data configuration unit 20. The target inference unit 12 resumes the operation of the configuration data inference unit 30 when an instruction from an operator or a preset condition such as elapse of a predetermined time is satisfied.

(2) The target inference unit 12 changes a threshold used for determining whether the inference in the configuration data inference unit 30 has succeeded or failed. For example, in a case where the confidence or the IoU is used for the determination, the target inference unit 12 lowers the threshold used for the determination.

(3) The target inference unit 12 sets the model used by the configuration data inference unit 30 as a model with higher accuracy. For example, in a case where the configuration data inference unit 30 uses a parameter designating a model, the target inference unit 12 changes the parameter in such a way to obtain a model with higher accuracy.

(4) The target inference unit 12 increases the scale of the model used by the configuration data inference unit 30. For example, in a case where the configuration data inference unit 30 uses a parameter designating a model, the target inference unit 12 changes the parameter to a parameter of a model of a larger scale.

(5) In a case where the data is an image, the target inference unit 12 increases the size of the image to be duplicated to the configuration image. For example, in a case where the data configuration unit 20 uses a parameter regarding duplication of an image, the target inference unit 12 changes the parameter to a parameter that increases the size of an image to be duplicated to the configuration image. For example, in a case where the data configuration unit 20 uses a parameter that designates the number of grids in the configuration image, the target inference unit 12 changes the parameter to a parameter that reduces the number of grids.

(6) In a case where a gap is provided between the images in the configuration image, the target inference unit 12 widens the gap. For example, in a case where the data configuration unit 20 uses a parameter of the width of the gap, the target inference unit 12 changes the parameter to a parameter for widening the gap.

(7) The target inference unit 12 increases the size of the configuration data. For example, in a case where the data configuration unit 20 uses a parameter that designates the size of the configuration image, the target inference unit 12 changes the parameter to a parameter that increases the size of the configuration image.

Furthermore, the information processing device 102 may adjust at least one operation in the information processing device 102 as follows based on a situation such as inference accuracy or inference speed in at least one of the configuration data inference unit 30 and the data inference unit 40. The at least one operation in the information processing device 102 is an operation in at least one of the target inference unit 12, the data configuration unit 20, the configuration data inference unit 30, and the data inference unit 40. For example, the target inference unit 12 may execute the following operation as adjustment of the inference accuracy and the inference speed. In order to implement the following operation, the target inference unit 12 may change the predetermined parameter in the same manner as described above. However, in the following description, description of parameter change is omitted.

(1) The target inference unit 12 changes the model used by the configuration data inference unit 30 to a large-scale model. This change improves the inference accuracy of the configuration data inference unit 30. In a case where the number of times of inference in the data inference unit 40 is reduced as a result of the improvement in the inference accuracy of the configuration data inference unit 30, this change is a balance with the inference speed in the configuration data inference unit 30, but there is a possibility that the inference speed of the information processing device 102 is improved.

(2) The target inference unit 12 changes the model used by the data inference unit 40 to a large-scale model. This change improves the inference accuracy of the data inference unit 40.

(3) The target inference unit 12 changes the model used by the data inference unit 40 to a small-scale model. This change improves the inference speed of the data inference unit 40.

(4) The target inference unit 12 reduces the number of grids used by the data configuration unit 20. This change improves the inference accuracy of the configuration data inference unit 30.

(5) The target inference unit 12 increases the number of grids used by the data configuration unit 20. This change improves the inference speed of the configuration data inference unit 30.

(6) The target inference unit 12 widens the gap between the images used by the data configuration unit 20. This change improves the inference accuracy of the configuration data inference unit 30.

(7) The target inference unit 12 changes a threshold used for determining whether the inference in the configuration data inference unit 30 has succeeded or failed. For example, in a case where the confidence of inference is used for determination of success or failure, increasing the threshold of the confidence improves the inference accuracy of the configuration data inference unit 30.

Similarly to the data set generation unit 60, the data set generation unit 62 generates a learning data set using the original data set. However, in a case where at least one of the configuration data inference unit 30 and the data inference unit 40 uses a plurality of models, the data set generation unit 62 generates a plurality of learning data sets for generating each of the plurality of models. The data set generation unit 62 may generate a plurality of data sets using a plurality of original data sets. Alternatively, the data set generation unit 62 may generate a plurality of original data sets by applying a data augmentation method to the original data set, and generate a plurality of learning data sets using the plurality of generated original data sets. For example, the data set generation unit 62 may use at least one of horizontal inversion, vertical inversion, partial cropping, combining, enlargement/reduction, brightness adjustment, luminance adjustment, and color adjustment as a data expansion method. The data set generation unit 62 may use image processing different from the above.

Similarly to the data set storage unit 50, the data set storage unit 52 stores the learning data set used to generate the trained model used by the information processing device 102. However, in a case where at least one of the configuration data inference unit 30 and the data inference unit 40 uses a plurality of models, the data set storage unit 52 stores a plurality of learning data sets relevant to the plurality of models. The data set storage unit 52 may store a learning data set acquired from an operator or the like as at least some learning data sets.

Similarly to the model learning unit 70, the model learning unit 72 generates a trained model using the learning data set. However, in a case where at least one of the configuration data inference unit 30 and the data inference unit 40 uses a plurality of models, the model learning unit 72 generates a plurality of trained models. Then, the model learning unit 72 stores the generated trained model in the model storage unit 82.

Similarly to the model storage unit 80, the model storage unit 82 stores a trained model used for inference by the configuration data inference unit 30 and the data inference unit 40. However, in a case where at least one of the configuration data inference unit 30 and the data inference unit 40 uses a plurality of models, the model storage unit 82 stores a plurality of trained models. The model storage unit 82 stores the trained model generated by the model learning unit 72. However, the model storage unit 82 may store a trained model acquired in advance by the information processing device 102 from an operator or the like as at least some trained models. At least some of the plurality of trained models may be a model in which at least one of a model structure and a network structure is different from that of another trained model. For example, at least some trained models may be models different from other trained models in at least some following items.
(a) Learning data set,
(b) Network structure,
(c) Hyperparameter,
(d) Weight accuracy,
(e) Batch size,
(f) Parameters related to generation of a configuration image.

The information processing device 102 configured in this manner can improve the inference throughput and further switch the operation in the information processing device 102 to a more appropriate operation according to the situation of the inference operation, similarly to the second example embodiment. More specifically, the target inference unit 12 of the information processing device 102 switches the operation in the information processing device 102 to a more appropriate operation based on an inference situation in at least one of the configuration data inference unit 30 and the data inference unit 40. The inference situation may be inference accuracy or inference speed. However, the inference situation is not limited thereto. The operation of switching by the target inference unit 12 of the information processing device 102 is an operation in at least one of the target inference unit 12, the data configuration unit 20, the configuration data inference unit 30, and the data inference unit 40. The switching of the operation may be a change of a threshold used for determining whether the inference on the target included in the configuration data in the target inference unit 12 has succeeded or failed. Alternatively, the switching of the operation may be a change of a model used for inference in at least one of the configuration data inference unit 30 and the data inference unit 40. Alternatively, the switching of the operation may be a change in the size of the configuration data in the data configuration unit 20. Alternatively, the switching of the operation may be a combination of at least some above. However, the switching of the operation is not limited thereto. For example, in a case where the inference accuracy by the configuration data inference unit 30 decreases, the information processing device 102 may change the model used by the configuration data inference unit 30 to a more accurate model. Based on such an operation, the information processing device 102 achieves desired inference accuracy or inference speed while improving throughput.

### Hardware Configuration

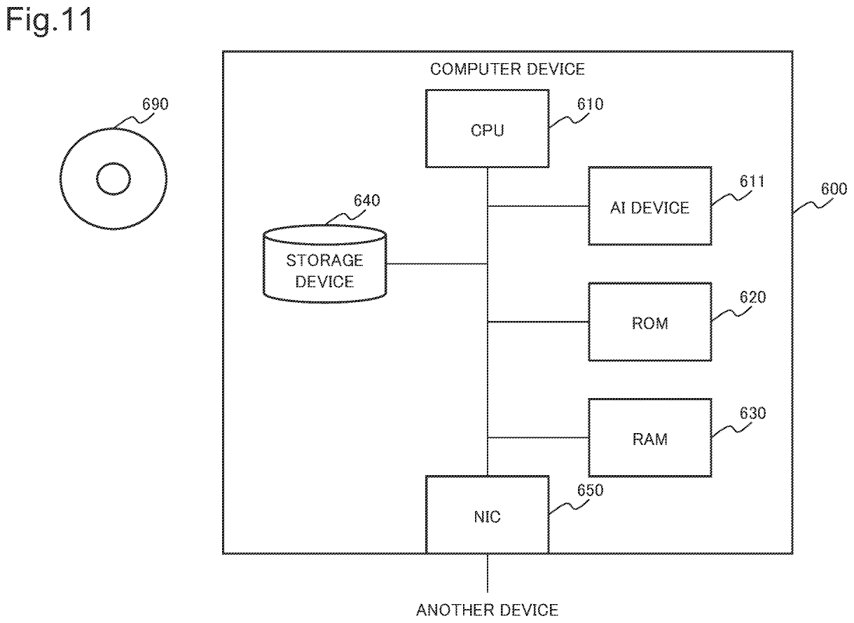

A hardware configuration of the information processing devices 100, 101, 102, and 103 will be described using the information processing device 100. In FIG. 11, the information processing device 100 includes all the configurations. However, the configuration of the information processing device 100 is not limited to the configuration of FIG. 11. For example, the information processing device 100 may be configured by connecting devices having functions relevant to the configurations via a predetermined network. For example, the information processing device 100 may be configured using cloud computing. Alternatively, in the information processing device 100, at least some of the plurality of configuration units may be configured by one piece of hardware. Alternatively, each component of the information processing device 100 may be configured by an individual hardware circuit.

Alternatively, the information processing device 100 may be implemented as a computer device including a CPU, a read only memory (ROM), and a random access memory (RAM). In addition to the above configuration, the information processing device 100 may be implemented as a computer device including a network interface circuit (NIC). Furthermore, the information processing device 100 may be implemented as a computer device including an AI device that executes part or all of machine learning and inference.

FIG. 11 is a block diagram illustrating a configuration of a computer device 600 which is an example of a hardware configuration of the information processing device 100. The computer device 600 includes a CPU 610, an AI device 611, a ROM 620, a RAM 630, a storage device 640, and an NIC 650, and constitutes a computer device.

The CPU 610 reads a program from at least one of the ROM 620 and the storage device 640. Then, the CPU 610 controls the AI device 611, the RAM 630, the storage device 640, and the NIC 650 based on the read program. Then, the computer device 600 including the CPU 610 controls these configurations and implements functions as the target inference unit 10, the data configuration unit 20, the configuration data inference unit 30, and the data inference unit 40. Furthermore, the computer device 600 including the CPU 610 implements each function as a data set storage unit 50, a data set generation unit 60, a model learning unit 70, a model storage unit 80, and a data acquisition unit 90.

When implementing each function, the CPU 610 may use the RAM 630 or the storage device 640 as a temporary storage medium of the program. The CPU 610 may read the program included in the recording medium 690 storing the program in a computer readable manner using a recording medium reading device (not illustrated). Alternatively, the CPU 610 may receive a program from an external device (not illustrated) via the NIC 650, store the program in the RAM 630 or the storage device 640, and operate based on the stored program.

The AI device 611 is controlled by the CPU 610 to execute some or all processes of machine learning and inference. For example, the AI device 611 is a GPU, an FPGA, an ASIC, or an AI chip. In the execution of the processing, the AI device 611 is controlled by the CPU 610 to read information necessary for the execution of the processing, such as data, a program, or circuit information, from the ROM 620, the RAM 630, or the storage device 640.

The ROM 620 stores programs executed by the CPU 610 and fixed data. The ROM 620 may store information necessary for processing of the AI device 611. The ROM 620 is, for example, a programmable ROM (Programmable ROM (P-ROM)) or a flash ROM. The RAM 630 temporarily stores programs and data executed by the CPU 610. The RAM 630 may temporarily store information necessary for processing of the AI device 611. The RAM 630 is, for example, a dynamic RAM (Dynamic-RAM (D-RAM)).

The storage device 640 stores data and programs to be stored for a long time by the computer device 600. The storage device 640 may store information necessary for processing of the AI device 611. Alternatively, the storage device 640 may operate as the data set storage unit 50. Alternatively, the storage device 640 may operate as the model storage unit 80. Alternatively, the storage device 640 may operate as a temporary storage device of the CPU 610. The storage device 640 is, for example, a hard disk device, a magneto-optical disk device, a solid state drive (SSD), or a disk array device.

The ROM 620 and the storage device 640 are non-transitory recording media. On the other hand, the RAM 630 is a transitory recording medium. The CPU 610 is operable based on a program stored in the ROM 620, the storage device 640, or the RAM 630. That is, the CPU 610 can operate using a non-transitory recording medium or a transitory recording medium.

The NIC 650 relays exchange of data with an external device (not illustrated) via a network. The NIC 650 is, for example, a local area network (LAN) card. Furthermore, the NIC 650 is not limited to wired communication, and may be wireless communication.

The CPU 610 and the AI device 611 of the computer device 600 configured as described above can implement the same functions as those of the information processing device 100 based on the program, and thus the throughput of the inference processing is improved. The information processing device 101 in FIG. 1, the information processing device 103 in FIG. 9, or the information processing device 102 in FIG. 10 may be implemented using the computer device 600.

### System

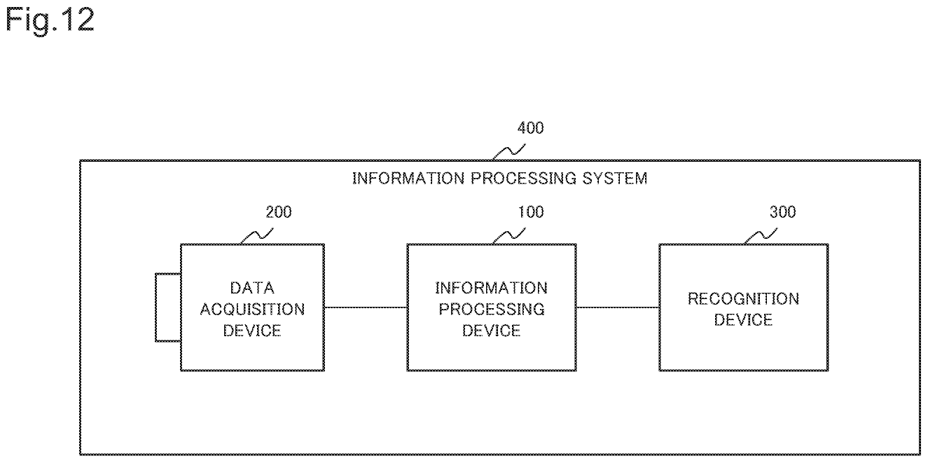

An example of a system including the information processing devices 100, 101, 102, and 103 will be described using the information processing device 100. FIG. 12 is a block diagram illustrating an example of a configuration of an information processing system 400 including the information processing device 100. The information processing system 400 includes the information processing device 100, a data acquisition device 200, and a recognition device 300. The information processing system 400 may include a plurality of devices as each of the devices. For example, the information processing system 400 may include a plurality of data acquisition devices 200. The information processing system 400 may include an information processing device 101, 102, or 103 instead of the information processing device 100.

The data acquisition device 200 acquires a plurality of pieces of data at least partially including an inference target, and outputs the plurality of pieces of data to the information processing device 100. The data acquisition device 200 may acquire the original data set, the learning data set, or the trained model used by the information processing device 100 and output the data set, the learning data set, or the trained model to the information processing device 100. The data acquisition device 200 is, for example, a monitoring camera. In this case, the data acquisition device 200 outputs the captured image to the information processing device 100 as data including the inference target. For example, the data acquisition device 200 acquires an image of the LP of the vehicle, and outputs an image of characters included in the acquired image to the information processing device 100. Alternatively, the data acquisition device 200 may be a device that stores inference data acquired in advance.

As described above, the information processing device 100 acquires data including an inference target from the data acquisition device 200, and performs inference on the target included in the acquired data by executing the operation described above. For example, in a case where the information processing device 100 executes an image classification task for alphanumeric characters, the information processing device 100 classifies an image acquired from the data acquisition device 200 into any one of numbers 0 to 9 and alphabets A to Z. Then, the information processing device 100 outputs the result of performing the inference on the target. For example, the information processing device 100 outputs the class of characters to the recognition device 300 as the result of performing the inference on the target. The information processing device 100 may output data used for inference such as an image including characters in accordance with the inference result.

The recognition device 300 executes recognition related to the object inferred by the information processing device 100 using the inference result acquired from the information processing device 100. For example, in a case where the information processing device 100 classifies an alphanumeric class in the image of the LP character, the recognition device 300 recognizes the LP of the vehicle using the classified alphanumeric class. In this case, the alphanumeric class is the inference result of the information processing device 100, and the LP recognition processing is recognition processing related to the target, that is, recognition processing in the recognition device 300. Furthermore, the recognition device 300 may output a recognition result. For example, the recognition device 300 may display the recognition result on a predetermined display device. For example, when the recognition device 300 recognizes the LP, the user can determine the LP by referring to the LP displayed on the display device.

As described above, the information processing system 400 includes the information processing device 100, the data acquisition device 200, and the recognition device 300. The data acquisition device 200 outputs a plurality of pieces of data at least partially including a target to the information processing device 100. The information processing device 100 performs inference on a target included in data. The recognition device 300 acquires the result of performing the inference on the target from the information processing device 100, and executes recognition related to the target based on the acquired inference result. For example, the data acquisition device 200 acquires an image including characters of the LP of a vehicle. The information processing device 100 infers a class of images of the characters. The recognition device 300 recognizes the LP based on the inferred class of the characters. Then, the information processing device 100 in the information processing system 400 implements inference with improved throughput. Therefore, the information processing system 400 improves the throughput of the recognition processing based on the inference result of the information processing device 100.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

### REFERENCE SIGNS LIST

10 target inference unit
11 target inference unit
12 target inference unit
20 data configuration unit
21 data configuration unit
23 data configuration unit
30 configuration data inference unit
31 configuration data inference unit
33 configuration data inference unit
40 data inference unit
41 data inference unit
50 data set storage unit
52 data set storage unit
60 data set generation unit
62 data set generation unit
70 model learning unit
72 model learning unit
80 model storage unit
82 model storage unit
90 data acquisition unit
100 information processing device
101 information processing device
102 information processing device
103 information processing device
600 computer device
610 CPU
611 AI device
620 ROM
630 RAM
640 storage device
650 NIC
690 recording medium

What is claimed is:

1. An information processing device comprising:
a memory configured to store instructions; and
one or more processors configured to execute the instructions to:
generate configuration data configured using a plurality of pieces of data, at least a portion of which including an inference target;
perform inference on the target included in the configuration data;
perform inference on the target included in the data in at least a portion of the data;
determine whether inference on the target included in the configuration data has succeeded or failed for each piece of the data constituting the configuration data;
perform inference on the target based on the configuration data and a result of performing inference on the target included in the configuration data as inference on the target included in the data for which inference on the target included in the configuration data has succeeded; and
perform inference on the target based on a result of performing inference on the target included in the data as inference on the target included in the data for which inference on the target included in the configuration data has failed.

2. The information processing device according to claim 1, further comprising:
the one or more processors are further configured to execute the instructions to:
generate second configuration data configured using a plurality of pieces of the data for which inference on the target included in the configuration data has failed;
perform inference on the target included in the second configuration data, wherein
determine whether inference on the target included in the second configuration data has succeeded or failed for each piece of the data constituting the second configuration data;
perform inference on the target based on the second configuration data and a result of performing inference on the target included in the second configuration data as inference on the target included in the data for which inference on the target included in the second configuration data has succeeded; and
perform inference on the target based on a result of performing inference on the target included in the data as inference on the target included in the data for which inference on the target included in the second configuration data has failed.

3. The information processing device according to claim 1, wherein
the one or more processors are further configured to execute the instructions to:
switch an operation in at least one of the generation of configuration data, the inference on the target in the configuration data, the inference on the target included in the data in at least a portion of the data, and the inference on the targe based on the configuration data and the result of performing inference on the target based on an inference situation in at least one of the inference on the target in the configuration data and the inference on the target included in the data in at least a portion of the data.

4. The information processing device according to claim 3, wherein
the inference situation is inference accuracy or inference speed, and
switching of an operation is a change of a threshold used for determining whether inference on the target included in the configuration data has succeeded or failed, a change of a model used for inference, a change of a size of the configuration data, or a combination thereof.

5. The information processing device according to claim 1, comprising:
the one or more processors are further configured to execute the instructions to:
generate a configuration data learning data set for generating a configuration data inference model and a data learning data set for generating a data inference model using a predetermined data set;
store the configuration data learning data set and the data learning data set;
generate a configuration data inference model by machine learning using the configuration data learning data set and generates a data inference model by machine learning using the data learning data set;
store the configuration data inference model and the data inference model;
acquire the data, wherein
generate the configuration data configured with the acquired data;
perform inference on the target included in the configuration data using the stored configuration data inference model; and
acquire the data on which an instruction is given; and
perform inference on the target included in the acquired data using the stored data inference model.

6. The information processing device according to claim 1, wherein
the data is an image of two-dimensional data, and
the one or more processors are further configured to execute the instructions to:
generate a configuration image in which a plurality of images are arranged on a two-dimensional plane;
execute an object detection task as inference on the target included in a configuration image; and
execute an image classification task as inference on the target included in an image.

7. (canceled)

8. An information processing method comprising:
generating configuration data configured using a plurality of pieces of data, at least a portion of which including an inference target;
performing inference on the target included in the configuration data;
performing inference on the target included in the data in at least a portion of the data;
determining whether inference on the target included in the configuration data has succeeded or failed for each piece of the data constituting the configuration data;
performing inference on the target based on the configuration data and a result of performing inference on the target included in the configuration data as inference on the target included in the data for which inference on the target included in the configuration data has succeeded; and
performing inference on the target based on a result of performing inference on the target included in the data as inference on the target included in the data for which inference on the target included in the configuration data has failed.

9. (canceled)

10. A non-transitory computer-readable recording medium having stored therein a program causing a computer to execute:
generating configuration data configured using a plurality of pieces of data, at least a portion of which including an inference target;
performing inference on the target included in the configuration data;
performing inference on the target included in the data in at least a portion of the data;
determining whether inference on the target included in the configuration data has succeeded or failed for each piece of the data constituting the configuration data;
performing inference on the target based on the configuration data and a result of performing inference on the target included in the configuration data as inference on the target included in the data for which inference on the target included in the configuration data has succeeded; and
performing inference on the target based on a result of performing inference on the target included in the data as inference on the target included in the data for which inference on the target included in the configuration data has failed.
